(19) United States
(12) Patent Application Publication
(10) Pub. No.: US 2006/0232119 A1
(43) Pub. Date: Oct. 19, 2006

(54) Device for protecting passengers on the chairs of a chairlift

(75) Inventor: Christoph Hinteregger, Wolfurt (AT)

Correspondence Address: LERNER GREENBERG STEMER LLP, P O BOX 2480, HOLLYWOOD, FL, 33022-2480, US

(73) Assignee: Innova Patent GmbH

(21) Appl. No.: 11/402,516

(22) Filed: Apr. 12, 2006

(30) Foreign Application Priority Data
Apr. 14, 2005 (AT) A 636/2005

(51) Int. Cl. B60R 21/00

(52) U.S. Cl. 297/487

(57) ABSTRACT

A chair of a chairlift has at least one seat with a seat surface and a pivotable closing bar. When the closing bar is closed, its crossbar extends across the thighs of a passenger. The crossbar bears a locking mechanism, which reduces the distance between the crossbar and the seat surface. The locking mechanism has a contact surface, which extends substantially parallel to the crossbar and faces towards the seat surface and the distance of which from the seat surface is variable. The variability of the distance of the contact surface from the seat surface allows an automatic adjustment to the length of the legs and thickness of the thighs. This prevents large persons from being cramped by the locking mechanism, whilst ensuring that small persons are securely held.

### BACKGROUND OF THE INVENTION

### FIELD OF THE INVENTION

The invention relates to a chair of a chairlift having at least one seat with a seat surface and having a pivotable closing bar. The crossbar of the closing bar, in the closed state, extends across the thighs of a passenger. A locking mechanism ensures that the distance between the crossbar and the seat surface is reduced.

In former times, chairs for chairlifts had one or two seats. More recently, they generally have four to eight seats situated side by side. In order to prevent the passengers from falling out of or slipping off the chair, these chairs have closing bars extending over the entire width of the chair. These closing bars can be swiveled, via pivot shafts disposed in the region of the backrest, from a position above the passengers into a position wherein a crossbar extends in front of the passengers above their thighs. On the closing bars, furthermore, there are also provided a number of footrests corresponding to the number of seats.

In the closing position, the closing bar, especially the crossbar, normally reliably prevents adults from sliding off or falling out. Since, however, the distance between the crossbar and the seat surface is dimensioned such that even large passengers with longer legs are comfortably accommodated beneath the crossbar, this distance is generally too large for smaller persons, with the result that it is possible for these smaller persons to slip through beneath the crossbar, especially if, due to their shorter legs, they are not capable of resting these on the footrests.

Proposals have already been made to reduce this danger, as are known, for example, from the commonly assigned Austrian patent AT 411 523 B, as well as its counterpart U.S. Pat. No. 6,691,624 B2, and Austrian patent AT 411 046 B. The measures which are known from these prior publications can essentially be summarized by stating that hoop guards or lobes are placed between the thighs of the respective user, from above or below. This often causes discomfort to passengers or users, however, and offers no protection if a small passenger is seated such that this hoop guard or lobe lies not between the legs but alongside the passenger.

### SUMMARY OF THE INVENTION

It is accordingly an object of the invention to provide a chair assembly for a cableway system, which overcomes the above-mentioned disadvantages of the heretofore-known devices and methods of this general type and which reliably prevents a person from slipping through between the seat surface and the crossbar, regardless of the size of the person and of his or her seating position on the chair.

With the foregoing and other objects in view there is provided, in accordance with the invention, a chair of a chairlift, comprising:
at least one seat with a seat surface;
a closing bar pivotally mounted between a closed position and an open position, said closing bar including a crossbar to be disposed, in the closed state, across the thighs of a passenger on said seat;
a locking mechanism disposed to reduce a distance between said crossbar and said seat surface, said locking mechanism having a contact surface extending substantially parallel to said crossbar and facing towards said seat surface, and wherein a distance between said contact surface and said seat surface is variable.

In other words, the objects of the invention are achieved in that the locking mechanism has a contact surface which extends substantially parallel to the crossbar and faces the seat surface and the distance of which from the seat surface is variable.

In the invention, the contact surface on the crossbar is disposed substantially parallel to the crossbar and rests from above on the thighs of the users, the variability of the distance of the contact surface from the seat surface allowing an automatic adjustment to the length of the legs and the thickness of the thighs. This prevents large persons from being cramped by the locking mechanism, whilst ensuring that small persons are securely held. Moreover, the, if necessary adjustable, gentle pressure of the locking mechanism upon the thighs of the passengers strengthens the subjective sense of security, especially of somewhat insecure persons, since they feel more securely held through contact with the safety bar. Finally, the invention ensures that each person, regardless of whether he or she is correctly seated in the middle of a seat, or, which occasionally happens in chairlifts with three or more seats, is seated centrally between two seats, is reliably prevented from slipping off.

In a preferred embodiment of the invention, the locking mechanism extends substantially over the entire width of the seat surface, since, as previously mentioned, each person in each seating position is in this case secured.

In a further embodiment, wherein the seat has two or more seat surfaces, the invention provides for the option that the locking mechanism extends over at least two mutually adjoining seat surfaces. This not only constitutes a simple construction, since a dedicated locking mechanism does not have to be built and fitted for each seat, but, as stated above, also ensures that even persons seated between two seats are safely secured.

A particularly simple and reliable embodiment of the invention is wherein the locking mechanism extends over the entire chair width, whereby the abovementioned advantages can be particularly well exploited.

In principle, in the invention, embodiments are conceivable which are wherein the distance between contact surface and crossbar is variable. That is to say that the contact surface, according to leg length and thigh thickness, can be forced or displaced in the direction of the crossbar.

A preferred embodiment in this context is wherein the contact surface is disposed on an elastically deformable element of the locking mechanism. In a practical embodiment, the locking mechanism would be, for example, an elongated part made of deformable plastic, for example, foam rubber, which, on the one hand, is fastened to the crossbar and, the contact surface of which, on the other hand, is facing the thighs of the passengers.

In another embodiment, the locking mechanism would not entirely consist of the elastically deformable element, but rather the elastically deformable element would merely be connected to the crossbar by a bracket or the like.

A further preferred embodiment of the invention is wherein the contact surface is disposed on a locking bar of the locking mechanism, which is disposed substantially parallel to the crossbar.

This locking bar could be a steel or plastic tube, for example, which is fastened to the crossbar. The contact surface could be directly located on this locking bar. However, the elastically deformable element bearing the contact surface could also conceivably be disposed on the locking bar, wherein case the locking bar forms the bracket for the element.

In the invention, the locking bar can be movable relative to the crossbar counter to an elastic force, the elastic force being able to be applied by one or more steel springs, for example. As soon as the closing bar is swiveled into its closing position, this spring forces the locking bar with gentle force against the thighs of the passengers.

Within the scope of the invention, three embodiments of how the locking bar can be moved relative to the crossbar are preferred.

One embodiment has the locking bar pivotally mounted.

A second embodiment has the locking bar connected to the crossbar by variable-length rods, e.g. telescopic rods.

A third embodiment has the locking bar connected to the crossbar by toggle joints.

In order further to increase the slip-through protection, it can also, finally, be envisaged that the contact surface has in the middle region of the seat surface a nose-like projection pointing towards the seat surface.

As is known from the above-noted Austrian patent AT 411 046 B, this nose-like projection, which, however, can have relatively small dimensions, would jut between the legs of a passenger provided he or she is correctly seated on the seat.

Other features which are considered as characteristic for the invention are set forth in the appended claims.

Although the invention is illustrated and described herein as embodied in a device for protecting passengers on the chairs of a chairlift, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows in diagrammatic representation a front view of a chair, according to the invention, of a chairlift;

FIG. 2 shows a section through the chair of FIG. 1 along the line II-II;

FIG. 3 shows a front view of a second embodiment of a chair according to the invention;

FIG. 4 shows a section through the chair of FIG. 3 along the line IV-IV;

FIG. 5 shows a front view of a third embodiment of a chair according to the invention;

FIG. 6 shows a section through the chair along the line VI-VI; and

FIGS. 7 and 8 show a fourth embodiment of a chair according to the invention in front and side view.

### DESCRIPTION OF THE PREFERRED EMBODIMENTS

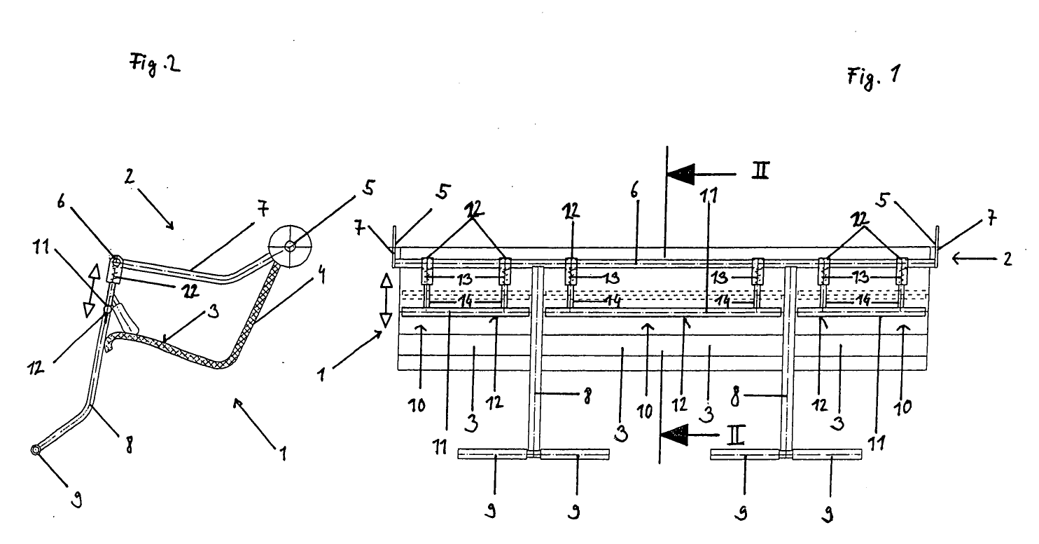

The chairs of a chairlift, in the basic diagrammatic illustrations of FIGS. 1-8, include a seat bench 1 and a closing bar 2. The other parts of the chair are well known. Should the reader require additional details, reference is had to the above-noted U.S. Pat. No. 6,691,624, which is incorporated herein. The seat bench 1 and the closing bar 2, respectively, are fastened to a supporting frame, which, if need be, is connected by a joint to a supporting rod, to the upper end of which there is fitted a clamping device for fastening or coupling the chair to a carrying and/or hauling cable. Where necessary, at the upper end of the supporting rod a running gear can be provided, which, after the chair has been decoupled from the carrying and/or hauling cable, serves to transport the chair along rails, provided in the stations, through the disembarkation and embarkation areas.

Referring now to the figures of the drawing in detail and first, particularly, to FIGS. 1 and 2 thereof, which represent a first exemplary embodiment of the invention, a seat bench 1 has four seat surfaces 3 and a backrest 4. In the region of the lateral, upper corners of the backrest 4, a closing bar 2 is mounted pivotably by means of hinges 5. The closing bar 2 can be swiveled upwards by somewhat more than 90° from its closing position represented in FIGS. 1 and 2, allowing the passengers to get freely in and out.

The closing bar 2 comprises a crossbar 6 extending over the entire width of the seat bench 1 or chair. The crossbar 6 is connected to the hinges 5 by side struts 7. Extending downwards from the crossbar 6 between, respectively, two seats are two vertical rods 8, to which two footrests 9 are respectively fastened, one for each seat 3.

The distance between the cross-strut 6 and the seat surfaces 3, in particular the front region thereof situated closest to the cross-strut 6, is dimensioned such that even persons with longer legs or lower legs, but also more corpulent persons, are comfortably accommodated beneath the cross-strut 6 when they put their feet on the footrests 9. On the other hand, this distance is dimensioned sufficiently large for small persons, especially children, for them to be able to slip through beneath the crossbar 6. This danger arises, in particular, from the fact that, in smaller persons, the legs are often too short to be put on the footrests 9.

In order to reduce this danger, locking mechanisms 10 are provided in the invention. A locking mechanism 10 is respectively located in the region of an outer seat 3, whilst a middle locking mechanism 10 extends over the two middle seats 3. In this illustrative embodiment, the locking mechanisms 10 respectively have a locking bar 11, which is fastened to the crossbar 6 by, respectively, two telescopic rods 22. The telescopic rods 22 contain compression springs 13, which force the portions 14 thereof attached to the locking bars 11 away from the crossbar 6, i.e. from the closing position of the closing bar 2 (represented in FIGS. 1 and 2) downwards in the direction of the seat surface 3. On their bottom side, the locking bars 1 have contact surfaces 12, which, owing to the arrangement of the locking bars 11, extend substantially parallel to the crossbar 6. The locking bars 11 rest with the contact surfaces 12, under gentle pressure of the springs 13, on the thighs of the passengers, the distance between the contact surface 12 and the seat surface 3 automatically adjusting by the telescopic rods 22 to the length and thickness of the legs. The spring-loaded embodiment of the locking mechanisms 10 with the telescopic rods 22 ensures, without help from the passengers, that the locking bars 11 rest on the legs of the passengers, thereby ensuring that even small persons are securely prevented from slipping through.

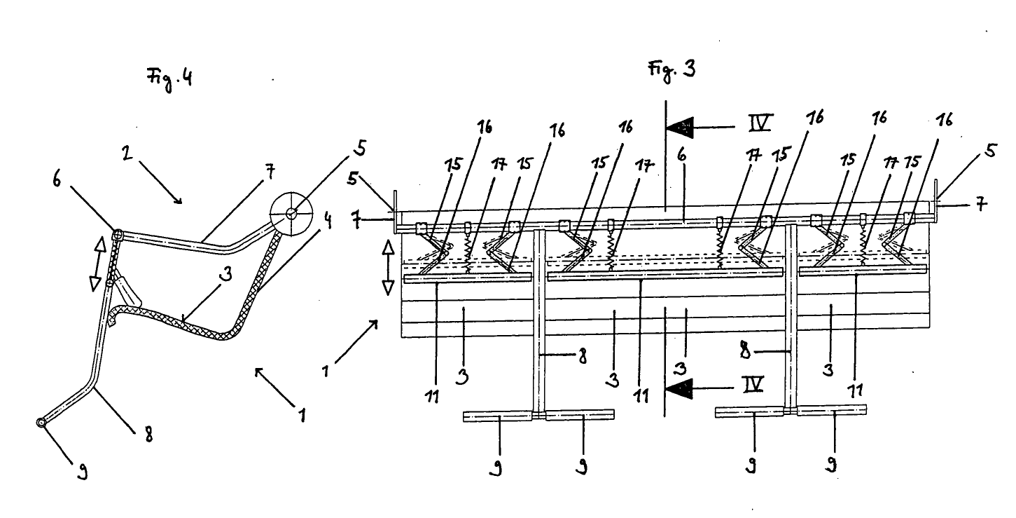

In the embodiment represented in FIGS. 3 and 4, the seat bench 1 and the closing bar 2, together with the footrests 9, are constructed essentially the same as in FIGS. 1 and 2. There is a difference, however, in the way wherein the locking bars 11 are connected to the crossbar 6. In the embodiment represented in FIGS. 3 and 4, the locking bars 11 are connected to the crossbar 6 by, respectively, two toggle joints having lever members 15 and 16. The pressure on the locking bars 11 is exerted with compression springs 17, which are clamped in place between the locking bars 11 and the crossbar 6. Alternatively, it would also be possible, for example, to fit leg springs in the region of the joints between the lever members 15 and the crossbar 6 and/or at joints between the lever members 15 and 16 and/or at the hinged connection between the lever members 16 and the locking bars 11.

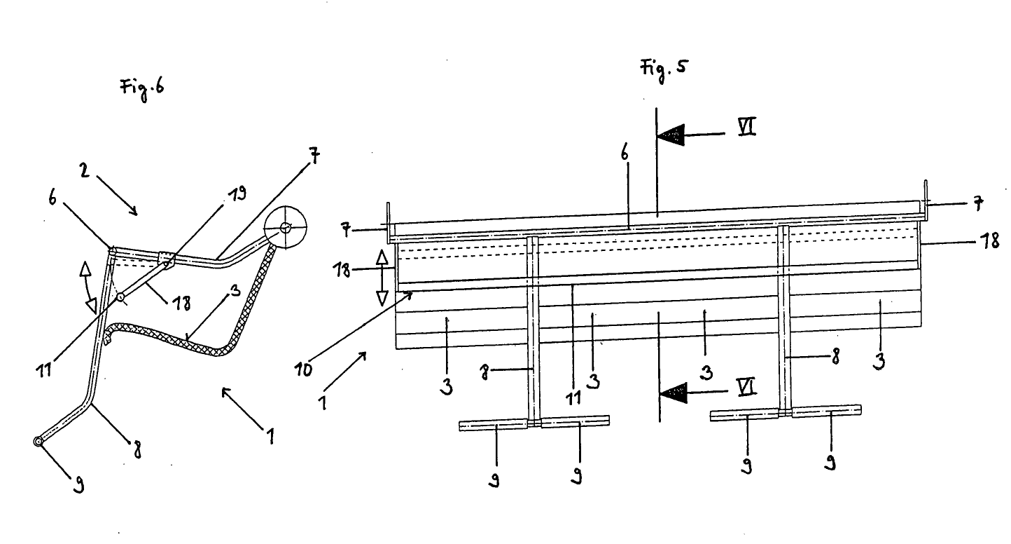

A further embodiment of the invention is represented in FIGS. 5 and 6, wherein the seat bench 1 and the closing bar 2 are again constructed as described in the preceding embodiments. In the embodiment of FIGS. 5 and 6, however, the locking bar 11 is hinge-connected to the side struts 7 of the crossbar 6 by side members 18. In the region of the two joints 19, leg springs, for example, are fitted, which force the locking bar 11 downwards over the side members 18, i.e. away from the crossbar 6 in the direction of the seat surface 3.

Also different from the preceding embodiments is the fact that, in this embodiment, the locking bar extends across the entire width of the chair or of the seat bench 1.

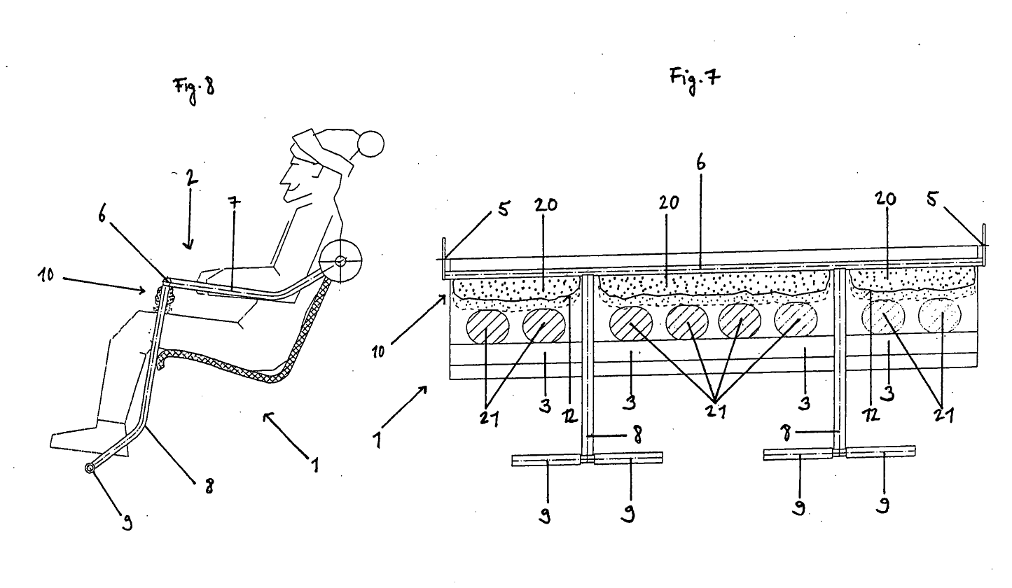

In the last embodiment, represented in FIGS. 7 and 8, the locking mechanism 10 comprises elastically deformable elements 20, a single element 20 being respectively assigned to the two outer seats, whereas the middle element 20 extends over the entire width of the two middle seats. Each element 20 consists, for example, of compressive plastic, for example foamed plastic, which, with its contact surface 12 facing away from the crossbar 6 and towards the thighs 21 (represented symbolically), rests on said thighs 21 when the closing bar 2 is in the closing position represented in FIGS. 7 and 8. In comparison to the previously described embodiments of FIGS. 1 and 2 and 5 and 6, this embodiment offers the advantage that the contact surface 12 adjusts individually to each single leg, which, in the illustrative embodiments represented in connection with FIGS. 1, 2 and 5, 6, is not always the case. For instance, in the embodiments according to FIGS. 1 and 2, an inadequate personal adjustment may be made on the two middle seats if the persons in question have a widely differing size. In the embodiment according to FIGS. 5 and 6, wherein the closing bar runs over the entire width, this problem could occur even more seriously.

In order to remedy this, in the embodiment of FIGS. 1 and 2, the construction of the telescopic rods and their fastening to the locking bars 11 and crossbar 6 can be realized with so much lateral freedom of movement that the locking bar 11, where necessary, can also adopt a position non-parallel to the crossbar 6, so that, if a smaller person is seated on one of the two middle seats, it can drop down further than with a larger person seated alongside.

Analogously, in the embodiment according to FIGS. 5 and 6, a tilt of the locking bar 11 relative to the crossbar 6 and seat surfaces 3, can be ensured, for example, by the side members 18 being hinge-connected to the locking bars 11, whereby the locking mechanism 10 is allowed to twist.

In the embodiment according to FIGS. 3 and 4, the use of the toggle joints 15, 16 automatically ensures that the locking bar 11 can tilt relative to the crossbar 6 and seat surfaces 3.

In addition, in the embodiments according to FIGS. 1 to 6, it could also be envisaged that the locking bars 11 are equipped with elastically deformable elements similar to the elements 20 of FIGS. 7 and 8, and are fully enclosed by these, so as to allow an additional flexible adjustment.

This application claims the priority, under 35 U.S.C. § 119, of Austrian patent application No. A 636/2005, filed Apr. 14, 2005; the entire disclosure of the prior application is herewith incorporated by reference.

I claim:

1. A chair of a chairlift, comprising:
at least one seat with a seat surface;
a closing bar pivotally mounted between a closed position and an open position, said closing bar including a crossbar to be disposed, in the closed state, across the thighs of a passenger on said seat;
a locking mechanism disposed to reduce a distance between said crossbar and said seat surface, said locking mechanism having a contact surface extending substantially parallel to said crossbar and facing towards said seat surface, and wherein a distance between said contact surface and said seat surface is variable.

2. The chair according to claim 1, wherein said locking mechanism extends substantially over an entire width of said seat surface.

3. The chair according to claim 1, wherein said seat is formed with two or more seat surfaces and said locking mechanism extends over at least two mutually adjoining seat surfaces.

4. The chair according to claim 1, wherein said locking mechanism extends over an entire chair width.

5. The chair according to claim 1, wherein a distance between said contact surface and said crossbar is variable.

6. The chair according to claim 5, wherein said contact surface is disposed on an elastically deformable element of said locking mechanism.

7. The chair according to claim 5, wherein said locking mechanism is formed of an elastically deformable element.

8. The chair according to claim 1, wherein said contact surface is disposed on a locking bar of said locking mechanism, and said locking bar extends substantially parallel to said crossbar.

9. The chair according to claim 8, wherein said locking bar is movable relative to said crossbar counter to an elastic force.

10. The chair according to claim 8, wherein said locking bar is pivotably mounted.

11. The chair according to claim 8, which comprises variable-length rods connecting said locking bar to said crossbar.

12. The chair according to claim 11, wherein said variable-length rods telescopic rods.

13. The chair according to claim 8, wherein said locking bar is connected to said crossbar by way of toggle joints.

14. The chair according to claim 1, wherein said seat surface has a middle region, and said contact surface is formed, in the middle region of the seat surface, with a nose-like projection pointing towards the seat surface.
